(19) United States
(12) Patent Application Publication
(10) Pub. No.: US 2006/0062630 A1
(43) Pub. Date: Mar. 23, 2006

(54) Detachable liquid chalk assembly

(76) Inventor: Thomas Yeh, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/944,738

(22) Filed: Sep. 21, 2004

(51) Int. Cl. B43K 27/02; B05C 1/00; A47L 1/08

(52) U.S. Cl. 401/18; 401/17; 401/23

(57) ABSTRACT

A liquid chalk assembly includes a first and a second liquid chalk module that are connected together via a first coupling sleeve to point two writing heads provided at front ends of the two modules to two opposite directions. A second coupling sleeve may be further provided to connect at a first end to the front end of the first liquid chalk module and at a second end to a rear end of a third liquid chalk module. Since differently colored liquid chalk material may be contained in different modules, the liquid chalk assembly provides a user with a wide choice of colors in writing.

### FIELD OF THE INVENTION

The present invention relates to a liquid chalk assembly, and more particularly to a liquid chalk assembly consisting of a plurality of removably connected liquid chalk modules.

### BACKGROUND OF THE INVENTION

Chalk is widely employed for writing, marking, or drawing on a blackboard, a wall, a floor, or any other surface. Conventionally, the chalk is in the form of a long stem. Later, there is liquid chalk developed and introduced into the market.

The currently available liquid chalk mainly includes a barrel having liquid chalk material contained therein and a writing head provided at an end thereof. A user may write with the writing head of the liquid chalk on a smooth surface, such as a glass surface, to show characters, designs or marks.

All the currently commercially available liquid chalk products include one single barrel containing liquid chalk material in only one color, which is released from the writing head at one end of the barrel for writing. When it is desired to write in different colors to distinguish words or designs from one another, an increased cost is required to buy multiple pieces of liquid chalk of different colors for use.

Moreover, for a user to hold the liquid chalk conveniently, the liquid chalk must include a hollow barrel of a predetermined length, which prevents the liquid chalk from being shortened to facilitate compact and economical packaging thereof. That is, the currently available liquid chalk products having a considerably large length must be packed in a box that must not be too large to be carried conveniently or too small to neatly accommodate the long liquid chalk. Under this circumstance, it is uneasy to pack as many differently colored liquid chalks as possible in the same packaging box.

### SUMMARY OF THE INVENTION

A primary object of the present invention is to provide a liquid chalk assembly consisting of multiple differently colored liquid chalk modules to provide a user with a wide choice of colors in writing with liquid chalks.

Another object of the present invention is to provide a liquid chalk assembly that not only conveniently provides a wide choice of colored liquid chalks, but also an overall length suitable for a user to hold it comfortably for writing. The liquid chalk assembly includes at least two modules, each of which has a differently colored liquid chalk material contained therein. The modules are serially connected together to have an overall length that allows a user to comfortable hold the liquid chalk assembly for writing.

In brief, the liquid chalk assembly of the present invention provides users with a wide choice of colored liquid chalks without adversely affecting the structure of the liquid chalk assembly for convenient use thereof.

To achieve the above objects, in accordance with the present invention, there is provided a liquid chalk assembly which includes a first and a second liquid chalk module that are connected together via a first coupling sleeve to point two writing heads provided at front ends of the two modules to two opposite directions. A second coupling sleeve may be further provided to connect at a first end to the front end of the first liquid chalk module and at a second end to a rear end of a third liquid chalk module. Since differently colored liquid chalk material may be contained in different modules, the liquid chalk assembly provides a user with a wide choice of colors in writing.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a liquid chalk assembly according to a first embodiment of the present invention;

FIG. 2 is an exploded perspective view of FIG. 1;

FIG. 3 is a sectional view taken along line 3-3 of FIG. 1;

FIG. 4 is an exploded view of FIG. 3;

FIG. 5 is a perspective view of a liquid chalk assembly according to a second embodiment of the present invention;

FIG. 6 is an exploded perspective view of FIG. 5; and

FIG. 7 is an exploded sectional view of FIG. 5.

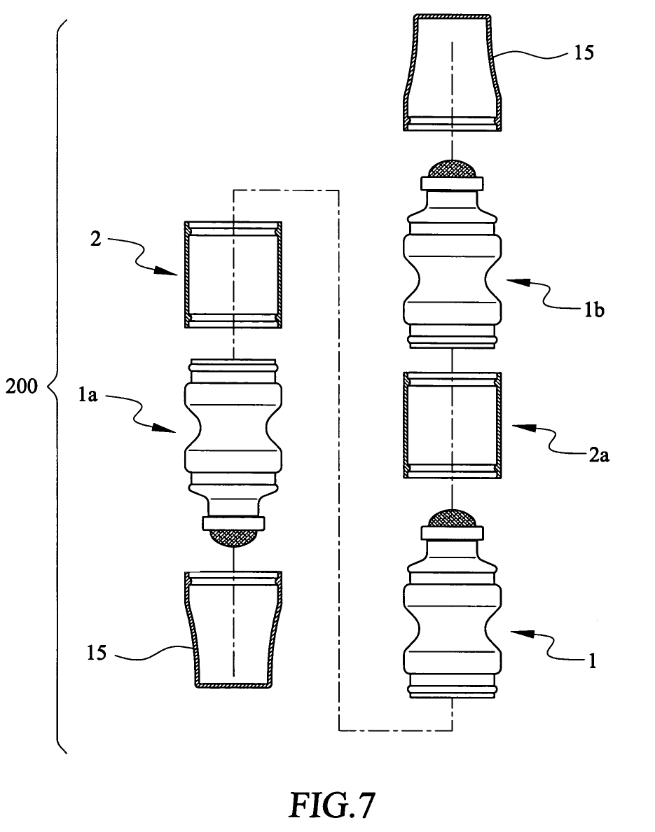

### DETAILED DESCRIPTION OF THE PREFERRED EMBODIMENTS

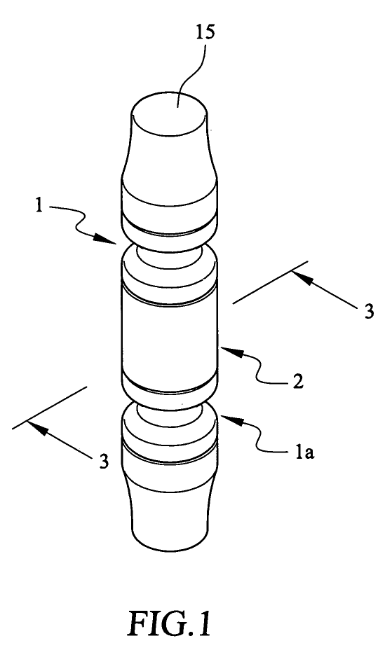

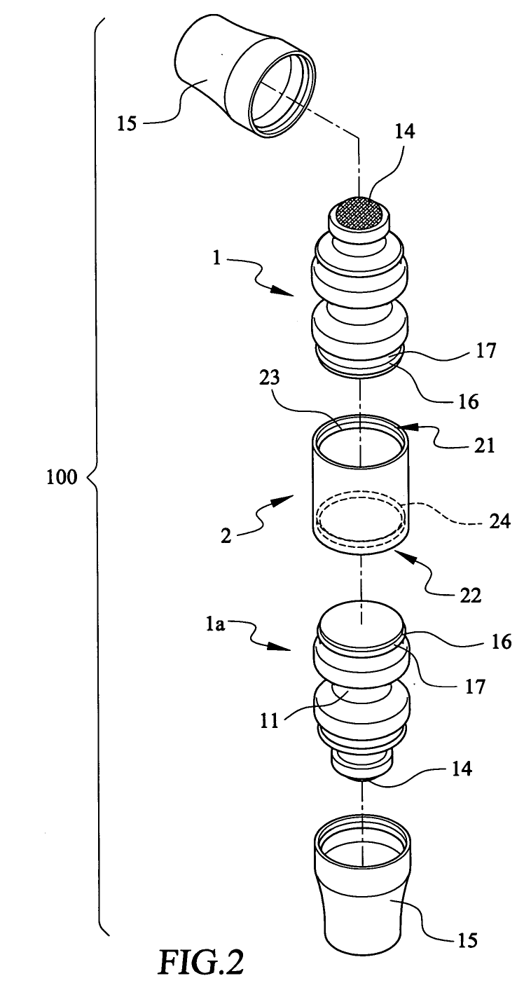

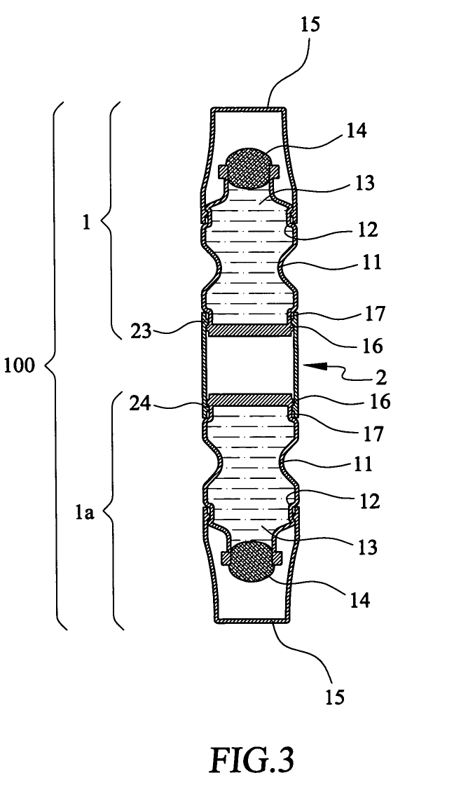

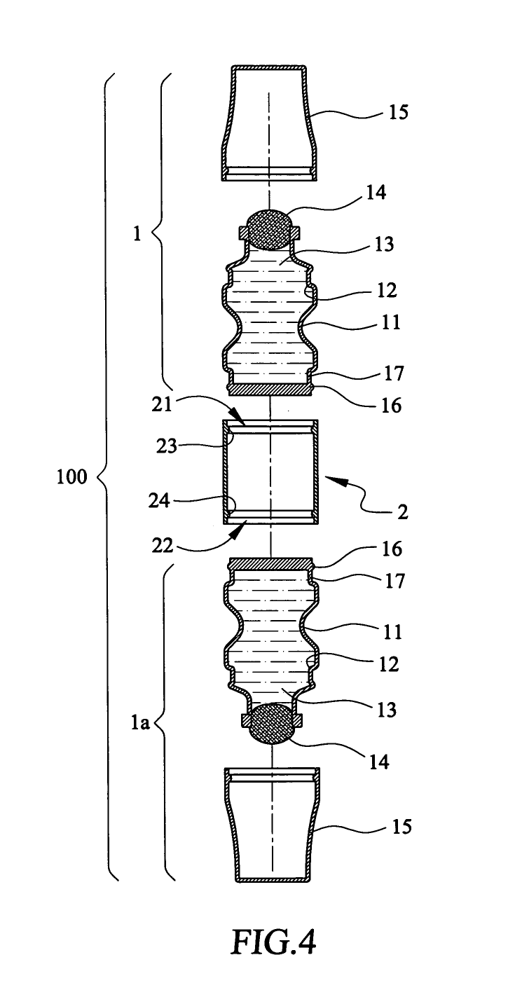

Please refer to FIGS. 1 and 2 that are assembled and exploded perspective views, respectively, of a liquid chalk assembly 100 according to a first embodiment of the present invention. As shown, the liquid chalk assembly 100 includes a first and a second liquid chalk module 1, 1a. As can be seen from FIGS. 3 and 4, which are assembled and exploded sectional views, respectively, of the liquid chalk assembly 100, each of the first and second liquid chalk modules 1 and 1a includes a hollow tubular body 11 defining a liquid chalk chamber 12 for containing a predetermined amount of liquid chalk material 13 therein.

The tubular body 11 is made of a material with suitable elasticity, and provided at a front end with a writing head 14, so that the liquid chalk material 13 in the tubular body 11 is released from the writing head 14 when the tubular body 11 is slightly compressed, allowing a user to write on a glass surface, a smooth panel surface, or any other surface with the writing head 14. A cap 15 is removably closed to the writing head 14 to protect the same.

The tubular body 11 has a closed rear end that includes a coupling section 16. An annular groove 17 is externally formed near a middle point of the coupling section 16 to serve as a retaining structure. A coupling sleeve 2 having open first and second ends 21, 22 is removably but firmly connected at the two open ends to the coupling sections 16 of the tubular bodies 11 of the first and second liquid chalk modules 1, 1a. Annular ribs 23, 24 are separately formed in the open ends 21, 22 of the coupling sleeve 2.

More specifically, the coupling sleeve 2 is removably connected at the first open end 21 to the tubular body 11 of the first liquid chalk module 1 by engaging the annular rib 23 formed in the first open end 21 of the coupling sleeve 2 with the external annular groove 17 formed on the coupling section 16 of the tubular body 11 of the first liquid chalk module 1.

Similarly, the coupling sleeve 2 is removably connected at the second open end 22 to the second liquid chalk module 1a, which is structurally identical to the first liquid chalk module 1 to include a hollow tubular body 11, a liquid chalk chamber 12, an amount of liquid chalk material 13, a writing head 14, a cap 15, a coupling section 16, and an external annular groove 17.

The first and the second liquid chalk module 1, 1a have differently colored chalk material contained therein. When it is desired to use the first liquid chalk module 1 to write, simply remove the cap 15 from the writing head 14 of the first liquid chalk module 1. And, when it is desired to use the second liquid chalk module 1a to write, simply remove cap 15 from the writing head 14 of the second liquid chalk module 1a. The first and the second liquid chalk module 1, 1a and the coupling sleeve 2 connecting the two modules 1, 1a to each other together define an overall length sufficient for a user to hold the liquid chalk assembly 100 comfortably during writing.

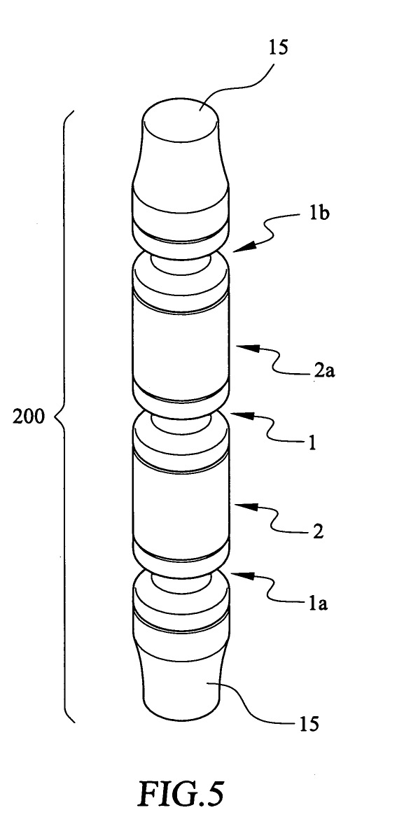

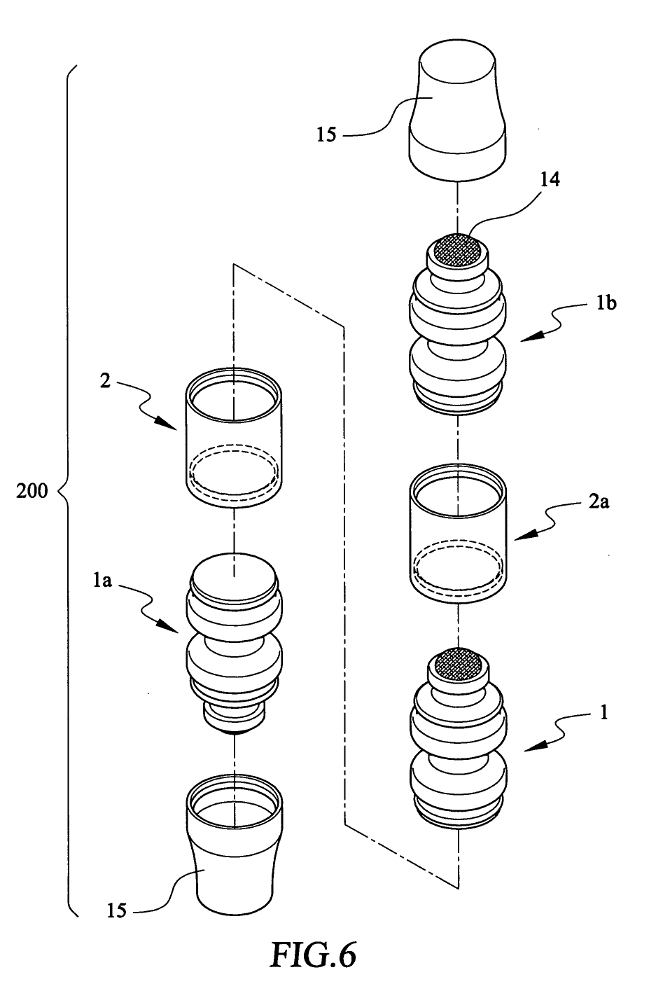

FIGS. 5 and 6 are assembled and exploded perspective views, respectively, of a liquid chalk assembly 200 according to a second embodiment of the present invention. The liquid chalk assembly 200 includes a first, a second, and a third liquid chalk module 1, 1a, 1b. The first and the second module 1, 1a are removably connected together via a first coupling sleeve 2 with their rear ends facing toward each other. As in the first embodiment, each of the first, the second, and the third liquid chalk module 1, 1a, 1b includes a hollow tubular body 11, a liquid chalk chamber 12, an amount of liquid chalk material 13 contained in the chamber 12, a coupling section 16, and an external annular groove 17, and the first coupling sleeve 2 includes a first open end 21, a second open end 22, and two annular ribs 23, 24 provided in the first and the second open ends 21, 22.

In the second embodiment of the present invention, there is further included a second coupling sleeve 2a removably connected at an end to a front end of the first liquid chalk module 1. The second coupling sleeve 2a is structurally identical to the first coupling sleeve 2. The other end of the second coupling sleeve 2a is removably connected to a rear end of the third liquid chalk module 1b, and a further cap 15 is closed to a front end of the third liquid chalk module 1b.

In practical production of the liquid chalk assembly 200, the first, the second, and the third liquid chalk module 1, 1a, 1b have differently colored liquid chalk material contained therein, and the user may choose any one of the three modules to write as needed.

The present invention has been described with some preferred embodiments thereof and it is understood that many changes and modifications in the described embodiments can be carried out without departing from the scope and the spirit of the invention intended to be limited only by the appended claims.

What is claimed is:

1. A liquid chalk assembly, comprising:
a first liquid chalk module having a hollow tubular body, which has an open front end provided with a writing head and a closed rear end provided with a coupling section;
a second liquid chalk module having a hollow tubular body, which has an open front end provided with a writing head and a closed rear end provided with a coupling section; and
a first coupling sleeve having a first and a second open end; and
said first coupling sleeve being removably connected at said first open end to said coupling section on said tubular body of said first liquid chalk module, and at said second open end to said coupling section on said tubular body of said second liquid chalk module, such that said first and said second liquid chalk module are connected together via said first coupling sleeve with said writing heads thereof pointed outward to two opposite directions.

2. The liquid chalk assembly as claimed in claim 1, wherein said first and said second liquid chalk module are provided at said coupling sections with an external annular groove each, and said first coupling sleeve being provided in said first and said second open end with an annular rib each; and said annular ribs in said first and said second open end of said first coupling sleeve being engaged with said external annular grooves on said coupling sections of said first and said second liquid chalk module, respectively, when said first coupling sleeve is connected at said first and said second open ends to said rear ends of said first and said second liquid chalk module, respectively.

3. The liquid chalk assembly as claimed in claim 1, wherein said first and said second liquid chalk module are made of a material having a predetermined elasticity to define a liquid chalk chamber each for containing an amount of liquid chalk material therein.

4. The liquid chalk assembly as claimed in claim 1, wherein said first and said second liquid chalk module are provided with a cap each for closing said writing heads.

5. The liquid chalk assembly as claimed in claim 1, further comprising a second coupling sleeve having two open ends; and said second coupling sleeve being connected at one of said two open ends to said writing head of said first liquid chalk module, and at the other open end to a closed rear end of a third liquid chalk module.

6. The liquid chalk assembly as claimed in claim 5, wherein said third liquid chalk module is provided at a front end with a writing head, which is removably closed with a cap.
